(19) United States
(12) Patent Application Publication
(10) Pub. No.: US 2010/0031337 A1
(43) Pub. Date: Feb. 4, 2010

(54) METHODS AND SYSTEMS FOR DISTRIBUTED SECURITY PROCESSING

(75) Inventors: Jeffrey T. Black, Boston, MA (US); Steve Zhou, Bedford, MA (US)

Correspondence Address: GOODWIN PROCTER LLP;PATENT ADMINISTRATOR, 53 STATE STREET, EXCHANGE PLACE, BOSTON, MA, 02109-2881, US

(73) Assignee: Certeon, Inc., Burlington, MA (US)

(21) Appl. No.: 11/961,971

(22) Filed: Dec. 20, 2007

Related U.S. Application Data
(60) Provisional application No. 60/922,518, filed on Apr. 9, 2007.

(51) Int. Cl. H04L 29/06; G06F 15/16

(52) U.S. Cl. 726/10; 709/217; 726/6; 726/12

(57) ABSTRACT

Methods and systems for processing information that is secured in transit between communicating computers utilizing a security protocol. In accordance with one embodiment of the present invention, processing with respect to the security protocol is performed by an intermediate network device located remotely from a secure data center, while maintaining the security of persistent credentials such as passwords and private cryptographic keys. The invention may be employed in conjunction with beneficial networking functions such as acceleration, traffic management and monitoring, content filtering, and the like, allowing such functions to be performed on secured traffic. The invention allows the remotely located network device to perform security protocol processing on behalf of a computer without having direct access to the persistent credentials of that computer, thereby improving overall system security.

### CROSS-REFERENCE TO RELATED APPLICATIONS

This application claims the benefit of U.S. Provisional Patent Application No. 60/922,518, filed on Apr. 9, 2007, which is hereby incorporated by reference as if set forth herein in its entirety.

### FIELD OF THE INVENTION

The present invention relates to methods and apparatus for communicating data and, more particularly, to methods and systems for processing information that is secured in transit between communicating computers utilizing a security protocol.

### BACKGROUND OF THE INVENTION

Computer networks are used today to carry sensitive or confidential information of many types. Banking and financial data, credit card numbers, and proprietary corporate documents are just a few examples. As this information is transmitted over private or public networks including the Internet, specific measures should be taken to protect it from unauthorized access.

In addressing this need, a number of security protocols, or suites of protocols, have been adopted in recent years to protect information when it is in transit between computers. The goals of these security protocols include:
Authentication: Ensuring that information is transmitted to, and received from, a trusted party.
Privacy: Preventing unauthorized parties from intercepting transmitted information through the use of cryptographic ciphers.
Integrity: Ensuring information has not been modified during transmission.
Anti-Replay: Ensuring information is not retransmitted by an unauthorized party.

Several secure protocol suites are in widespread use today. While they are similar in that they strive to meet one or more of the goals outlined above, these protocols vary with respect to the type of traffic they handle, their intended use, and their placement within the Open Systems Interconnection (OSI) reference model. Examples of secure protocol suites include:
Internet Protocol Security (Ipsec)—Operates at the Internet Protocol (IP) packet layer. Can be applied to any transmissions utilizing IP.
Secure Socket Layer (SSL) and its successor Transport Layer Security (TLS)—Operate at the session layer. Commonly utilized for Secure Hypertext Transfer Protocol (HTTPS) communications over the World Wide Web.
SMB Signing—Operates specifically on Server Message Block (SMB) messages. Commonly used in accessing shared directories over the Common Internet File System (CIFS).
Web Services Security (WSS)—Operates specifically to secure Simple Object Access Protocol (SOAP) messages.

### Problems Created by Security Protocols

Because security protocols are designed to protect information in transit over computer networks by preventing unauthorized eavesdropping and malicious attacks, they naturally have the effect of inhibiting the processing of the traffic for beneficial purposes by intermediate devices within the network. More specifically, today's computer networks, especially those within government or corporate enterprise environments, typically utilize devices that improve the performance or management of applications running over the network. These devices often sit in the network path between communicating computers and inspect and process information contained in the transmitted traffic. Examples of the processing performed by these intermediate network devices are:
Acceleration—Includes a number of techniques such as data reduction, caching, and protocol optimization to improve bandwidth requirements and responsiveness of applications running between computers.
Traffic Management—Prioritizing and shaping traffic according to the particular protocol, application, or computers involved.
Traffic Monitoring—Passively monitoring and reporting statistics associated with particular protocols, applications, or computers.
Content Filtering—Inspecting and filtering content elements embedded in traffic flows to identify and protect against malicious or unauthorized content. Examples include virus scanning and pornography filtering.

In the case where one or more security protocols are employed between the communicating computers, such intermediate devices may not have access to information contained in the transmitted traffic because of encryption employed by a security protocol. This fundamentally reduces or eliminates the ability of an intermediate device to carry out one or more of its designated tasks. Furthermore, because these protocols are designed to prevent ‘man-in-the-middle’ attacks, even in cases where encryption is not used, other mechanisms such as message authentication or ‘signing’ prevent the intermediate devices from manipulating traffic in ways that could otherwise improve application performance. For instance, message spoofing to mitigate against long network latencies would be prevented by the adoption of a security protocol that uses message signing.

Another concern with security protocols is the added processing burden they impose on the communicating computers themselves. In most all cases, these protocols utilize cryptographic ciphers or other complex mathematical computations to carry out authentication, to encrypt and decrypt data, and to generate cryptographic signatures. The computational load these steps impose on computers can significantly reduce their performance. This is especially true for servers that carry out secure communications with many other computers simultaneously.

### SUMMARY OF THE INVENTION

The present invention addresses the need of intermediate network devices that perform beneficial functions such as acceleration, traffic management and monitoring, content filtering, and the like, to gain access to clear text information and to manipulate traffic flows between communicating computers that utilize secure protocols. More specifically, the invention teaches methods and systems by which an intermediate network device can perform one or more of authentication, encryption and decryption, message signing, anti-reply, and the like, as required by a specific security protocol, without having benefit of persistent security credentials otherwise required for this processing. By employing embodiments of the invention in an intermediate network device performing one or more beneficial functions, it is possible to realize the effects of the beneficial functions even in environments where security protocols are employed between communicating computers. Embodiments of the invention have the following advantageous properties:
Transparency—The communicating computers need not have knowledge of the existence of or processing performed by one or more intermediate devices.
Security—Persistent security credentials are not transmitted over the network and can remain within a physically secure environment.
Offload—Computationally complex operations are offloaded from servers to intermediate devices, thereby improving server performance.
Localization—Messaging associated with the establishment of a secure channel can be carried out between a communicating computer and a co-located intermediate device, minimizing transmissions over slower WAN links and thereby improving performance.

In one aspect, the present invention relates to a method of communicating data between first and second computers located remotely from each other. A security proxy and a credentials manager comprising a database and a facility for deriving transitory credentials is provided. A secure communications session between the first computer and the security proxy is established, utilizing communications between the security proxy and the credentials manager. A communications session is then conducted between the first and second computers via the security proxy.

The security proxy may process secured traffic from the first computer and forward the traffic to the second computer. The security proxy may process the secured traffic with or without further involvement from the credentials manager. The processing may include authentication, decryption, or anti-replay. In one embodiment, the security proxy processes unsecured traffic from the second computer and processes it into secured traffic, which is then forwarded to the first computer. The security proxy may process unsecured traffic into secured traffic with or without further involvement from the credentials manager and the processing may include authentication, encryption, or anti-replay.

In some embodiments, the security proxy is located with the first computer. In another embodiment, the facility for deriving transitory credentials utilizes persistent credentials, which may be derived via communication with an authentication service. The persistent credentials may be stored in a database. In other embodiments, the credentials manager performs all operations using the persistent credentials (e.g., passwords, private keys, or other secret information known by the second computer) so as to exclude the first computer and the security proxy from access thereto.

In still another embodiment, the method includes causing the security proxy to establish and maintain the secure connection with the first computer. This may further include authentication, session key derivation, encryption and decryption, or anti-replay with respect to the traffic communicated over the secure connection. The transmitted traffic may undergo acceleration, traffic management and monitoring, and content filtering, the facilities for which may be co-located with both the first and second computer.

In another aspect, the present invention relates to another method of communicating data between first and second computers located remotely from each other. The method includes providing first and second security proxies, and a credentials manager comprising a database and a facility for deriving transitory credentials. The method further includes establishing a secure communications session between the first computer and the first security proxy, utilizing communications between the first security proxy and the credentials manager. The method also includes establishing a secure communication session between the second computer and the second security proxy, utilizing communications between the second security proxy and the credentials manager. Finally, the method includes conducting a communications session between the first and second computers via the first and second security proxies.

In some embodiments, the security proxy may process secured traffic from the first computer and forward the traffic to the second computer via the second security proxy with or without further involvement from the credentials manager. In other embodiments, the first security proxy may process unsecured traffic originating from the second computer from the second security proxy, and process it into secured traffic which is forwarded to the first computer, with or without further involvement from the credentials manager. The second security proxy may process secured traffic from the second computer and forward the traffic to the first computer via the first security proxy, with or without further involvement from the credentials manager. The second security proxy may also process unsecured traffic originating from the first computer from the first security proxy and process it into secured traffic which is forwarded to the second computer. The second security proxy may process the unsecured traffic into secured traffic without further involvement from the credentials manager. In all these embodiments, the processing may include steps of authentication, decryption, and anti-replay.

In other embodiments, the first security proxy is co-located with the first computer and the second security proxy is co-located with the second computer. The facility for deriving transitory credentials may utilize persistent credentials, where the persistent credentials may be derived via communication with an authentication service and may be stored in a database. Moreover, the persistent credentials may be passwords, private keys, and other secret information known by the second computer, and the credential manager may perform all operations using the persistent credentials so as to exclude the first computer and the first security proxy from access to them. Likewise, the persistent credentials may be passwords, private keys, and other secret information known by the first computer, and the credential manager may perform all operations using the persistent credentials so as to exclude the second computer and the second security proxy from access to them.

The method may comprise causing the first security proxy to establish and maintain the secure connection with the first computer, and further comprise of authentication, session key derivation, encryption and decryption, and anti-replay with respect to traffic communicated over the secure connection. In some embodiments, the second security proxy may establish and maintain the secure connection with the second computer, and comprise authentication, session key derivation, encryption and decryption, or anti-replay with respect to the traffic communicated over the secure connection. In both these embodiments, the transmitted traffic may undergo acceleration, traffic management and monitoring and content filtering.

In yet another aspect, the present invention relates to a system for the processing of data communicated between first and second computers located remotely from each other. The system includes a security proxy and a credentials manager comprising a database and a facility for deriving transitory credentials. The system also includes a secure communications session established between the first computer and the security proxy which utilizes communications between the security proxy and the credentials manager. The system also includes a communications session conducted between the first and second computers via the security proxy.

In some embodiments, the communications between the security proxy and the credentials manager may be via a secure channel between the two. The secure communications session between the first computer and the security proxy may be performed using IPsec, SSL, TLS, SMB signing or WSS. Moreover, the authentication steps performed between the first computer and the security proxy may use PKI certificates, NTLM challenge/responses, Kerberos tickets or shared secrets.

In a final aspect, the present invention relates to a system for the processing of data communicated between first and second computers located remotely from each other which includes first and second security proxies and a credentials manager comprising a database and a facility for deriving transitory credentials. The system further includes a secure communications session established between the first computer and the first security proxy which utilizes communications between the first security proxy and the credentials manager. The system also includes a secure communications session conducted between the second computer and the second security proxy which utilizes communications between the second security proxy and the credentials manager as well as a communications session conducted between the first and second computers via the first and second security proxies.

The communications between the first security proxy and the credential manager and the communications between the second security proxy and the credential manager may be via a secure channel between the two. Also, the secure communication session between the first computer and the first security proxy and the secure communications session between the second computer and the second security proxy may be performed using IPsec, SSL, TLS, SMB signing or WSS. Moreover, authentication steps performed between the first computer and the first security proxy and between the second computer and the second security proxy may be use PKI certificates, NTLM challenge/responses, Kerberos tickets or shared secrets. In some embodiments, traffic is exchanged between the first and second security proxies via a secure channel between the two.

### BRIEF DESCRIPTION OF THE DRAWINGS

The foregoing and other objects, features, and advantages of the present invention, as well as the invention itself, will be more fully understood when read together with the accompanying drawings, in which:

FIG. 1 depicts security processing between communicating computers in a network utilizing security proxies, traffic processors, a credentials manager, and an authentication service;

FIG. 2 depicts a trusted intermediate device communicating with remote intermediate devices over WAN network facilities to provide a distributed security offload;

FIG. 3 depicts a trusted intermediate device communicating with remote intermediate devices over WAN network facilities to provide a distributed security offload with traffic processing;

FIG. 4 depicts a trusted intermediate device and separate intermediate devices embodying traffic processors communicating with remote intermediate devices over WAN network facilities to provide a distributed security offload with distributed traffic processing; and

FIG. 5 depicts a trusted intermediate device communicating with remote intermediate devices over WAN network facilities to provide distributed security and traffic processing.

In the drawings, like reference characters generally refer to corresponding parts throughout the different views. The drawings are not necessarily to scale, emphasis instead being placed on the principles and concepts of the invention.

### DETAILED DESCRIPTION OF THE INVENTION

Embodiments of the present invention typically utilize one or more of the following elements:
Credentials Manager (“CM”)—Processing function that is deemed to be a fully trusted participant within the overall security infrastructure. In this regard, the credentials manager may maintain a database in non-volatile storage which contains persistent security credentials. In addition, the credentials manager may be authorized to communicate with authentication servers and other servers within the security infrastructure in order to retrieve authorization information and other persistent security credentials.
Credentials Database—A database maintained by the credentials manager to store persistent credentials.
Persistent Credentials—Information, such as passwords, private keys, and other secret information, required to authorize and administer secure communications between communicating computers in accordance with one or more security protocols
Authentication Service (“AS”)—Processing function which provides authoritative information controlling secure communications between computers.
Authentication Protocol—Protocol by which the credentials manager communicates with the authentication service.
Security Proxy (“SP”)—Processing function which carries out steps of authentication, session key negotiation, encryption, decryption, message signing, and anti-reply, among others, in accordance with a security protocol, with regard to transmissions to and from a communicating computer.
Traffic Processor (“TP”)—Processing function which provides a beneficial effect within the network by processing, in specific ways, the traffic in transit between communicating computers. By way of example, the traffic processor may perform such functions as acceleration, traffic management, traffic monitoring, and content filtering.
Communicating Computer (“CC”)—A computer which may utilize a secure protocol in communications with another communicating computer.
Trusted Intermediate Device (“TID”)—A network attached device that is fully trusted within the security infrastructure. The credentials manager is a functional component of the trusted intermediate device. Optionally, the trusted intermediate device may also contain as functional components the security proxy and the traffic processor.
Remote Intermediate device (“RID”)—A network device that has a trust relationship only with the trusted intermediate device. In this regard, the remote intermediate device and the trusted intermediate device undertake steps to mutually authenticate each other and establish a secure communications channel between the two. The security proxy is a functional component of the remote intermediate device and communicates with the credentials manager residing within the trusted intermediate device via the secure communications channel. The purpose of this communication is to allow the security proxy to receive from the credentials manager certain transitory credentials that are required to carryout security protocol processing steps in conjunction with a communicating computer. The traffic processor is also a functional component of the remote intermediate device. The secure communications channel may also be used to transmit processed traffic between the traffic processors in the remote and trusted intermediate devices.
Transitory Credentials—Credentials which are pertinent to establishing a temporary communications channel (utilizing a security protocol) between the security proxy and a communicating computer. Transitory credentials are temporary in that they cannot be used to establish subsequent such communication channels between the security proxy and a communicating computer. Examples of transitory credentials include decrypted session pre-master keys and various other cryptographic transformations of session-specific seed material, such transformations requiring the use of secret information contained in the persistent credentials. Transitory credentials are used by the security proxy to derive session keys.
Session Keys—Cryptographic keys used for carrying out steps of authentication, encryption, decryption, signing, and the like, that are performed in accordance with a security protocol as related to a specific communications session between the security proxy and a communicating computer.

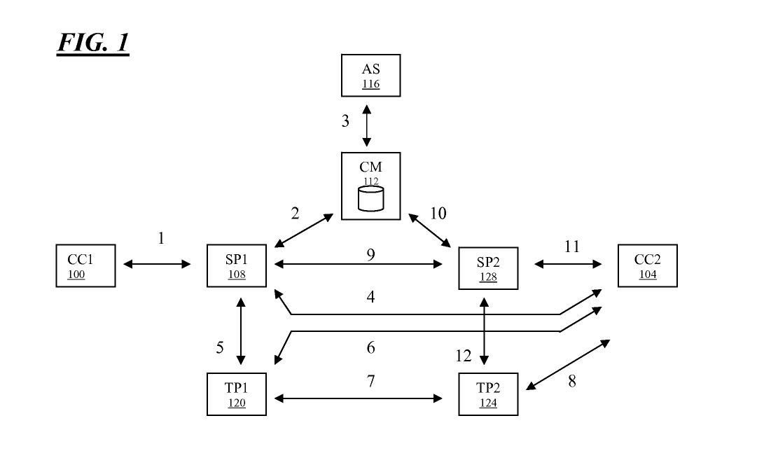

FIG. 1 illustrates elements and processing steps relating to the invention. More specifically, FIG. 1 shows the basic processing steps performed by the credentials manager 112, authentication service 116, security proxies 108, 128, and traffic processors 120, 124, along with the communication among these elements, and between these elements and communicating computers 100, 104.

Referring to FIG. 1, a first communicating computer (CC1) 100 initiates a secure connection utilizing a security protocol with a second communicating computer (CC2) 104. A first security proxy (SP1) 108, residing in the network path between CC1 100 and CC2 104, receives and intercepts this initiation sequence along path 1. In order for SP1 108 to negotiate the security protocol on behalf of CC2 104, SP 1 108 requires certain transitory credentials which can be derived by utilizing persistent credentials specific to CC2 104. To obtain these transitory credentials, the SP1 108 sends to the credentials manager (CM) 112, along path 2, certain information it derives during the establishment of the secure connection with CC1 100.

CM 112 utilizes the information received from SP1 108, in combination with persistent credentials specific to CC2 104 contained in its credentials database, to derive transitory credentials on behalf of SP1 108. Optionally, CM 112 may communicate with the authentication service (AS) 116 utilizing an authentication protocol along path 3 to retrieve such persistent credentials, which may be subsequently stored in its credentials database.

CM 112 then returns the transitory credentials to SP1 108 along path 2. SP1 108 utilizes the transitory credentials to derive one or more session keys as required to establish and maintain the secure connection with CC1 100. SP1 108 further communicates with CC1 100 over path 1 to complete session establishment and to transfer data.

Still referring to FIG. 1, in a first case, SP1 108 establishes a non-secure connection with CC2 104 on behalf of CC1 100 along path 4. Subsequent to establishing this connection, SP1 108 relays transmitting data between CC1 100 and CC2 104.

In a second case, SP1 108 relays transmitted data between CC1 100 and a first traffic processor (TP1) 120 along path 5. TP1 120 in turn establishes a non-secure connection with CC2 104 on behalf of CC1 100 along path 6. Subsequent to establishing this connection, TP1 120 relays data between SP1 108 and CC2 104. In conjunction with this, TP1 120 may perform certain beneficial processing of the relayed data such as acceleration, traffic management and monitoring, content filtering, and the like.

In a third case, SP1 108 relays transmitted data between CC1 100 and TP1 120 along path 5, TP1 120 in turn relaying transmitted data between SP1 108 and a second traffic processor (TP2) 124 along path 7. TP2 124 in turn establishes a non-secure connection with CC2 104 on behalf of CC1 100 along path 8. Subsequent to establishing this connection, TP2 124 relays data between TP1 120 and CC2 104. In conjunction with this, TP1 120 and TP2 124 may perform certain beneficial processing of the relayed data such as acceleration, traffic management and monitoring, content filtering, and the like.

In a fourth case, SP1 108 communicates with a second security proxy (SP2) 128 over path 9 in order to have SP2 128 initiate a secure connection with CC2 104 over path 11 on behalf of CC1 100. In order for SP2 128 to negotiate the security protocol on behalf of CC1 100, SP2 128 likewise requires certain transitory credentials which can be derived by utilizing persistent credentials specific to CC1 100. To obtain these transitory credentials, the SP2 128 sends to CM 112, along path 10, certain information it derives during the establishment of the secure connection with CC2 104. CM 112 likewise utilizes the information received from SP2 128, in combination with persistent credentials specific to CC1 100 contained in its credentials database, to derive transitory credentials on behalf of SP2 128.

Optionally, CM 112 may communicate with the authentication service (AS) 116 utilizing an authentication protocol along path 3 to retrieve such persistent credentials, which may be subsequently stored in its credentials database. CM 112 returns the transitory credentials to SP2 128 along path 10. SP2 128 utilizes the transitory credentials to derive one or more session keys as required to establish and maintain the secure connection with CC2 104. SP2 128 further communicates with CC2 104 over path 11 to complete session establishment and to transfer data. Transmitted data between CC1 100 and CC2 104 is relayed via SP1 108 and SP2 128 along paths 1, 9, and 11; or optionally via SP1 108, TP1 120, TP2 124, and SP2 128 along paths 1, 5, 7, 12, and 11, with TP1 120 and TP2 124 performing certain beneficial processing of the relayed data such as acceleration, traffic management and monitoring, content filtering, and the like.

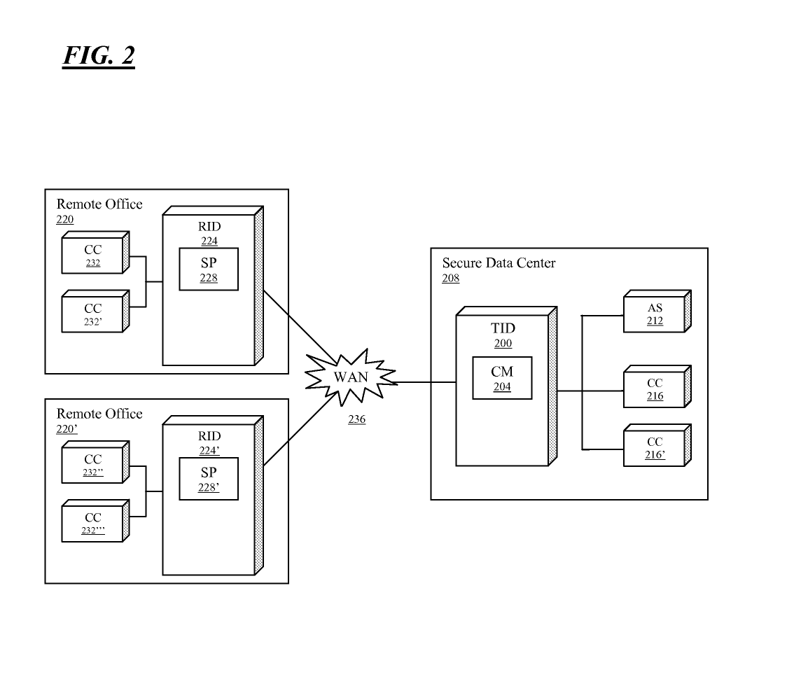

FIGS. 2-5 illustrate how the elements of the invention may be embodied within a trusted intermediate device and one or more remote intermediate devices, in various combinations, in order to carry out beneficial processing within a network of communicating computers which utilize security protocols.

Referring to FIG. 2, in one configuration a trusted intermediate device (TID) 200, containing a credentials manager 204, resides in a secure data center 208, interconnected over LAN facilities to an authentication service 212 and one or more communicating computers 216, 216′, also located in the data center 208. In one or more remote offices 220, 220′, two remote intermediate devices (RID) 224, 224′, each containing a security proxy 228, 228′, are interconnected over LAN facilities to one or more communicating computers 232, 232′, 232″, 232′″ located in remote offices 220, 220′. According to the invention, the RIDs 224, 224′ and the TID 200 (possibly involving the authentication service 212) communicate with each other over WAN facilities 236, utilizing a secure channel, in order to (1) allow the RIDs 224, 224′ to establish and maintain secure connections with their respective remote office communicating computers 232, 232′, 232″, 232′″, on behalf of the data center communicating computers 216, 216′; and (2) to relay data between the remote office communicating computers 232, 232′, 232″, 232′″ and the data center communicating computers 216, 216′.

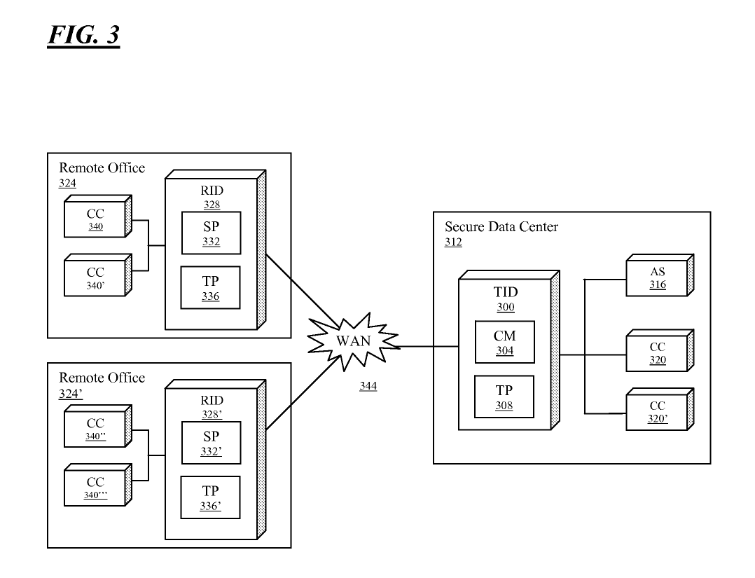

Referring to FIG. 3, in another configuration a TID 300, containing a credentials manager 304 and a traffic processor 308, resides in a secure data center 312, interconnected over LAN facilities to an authentication service 316 and one or more communicating computers 320, 320′, also located in the data center 312. In one or more remote offices 324, 324′, two RIDs 328, 328′, each containing a security proxy 332, 332′ and a traffic processor 336, 336′, are interconnected over LAN facilities to one or more communicating computers 340, 340′, 340″, 340″″ located in the remote offices 324, 324′. According to the invention, the RIDs 328, 328′ and the TID 300 (possibly involving the authentication service 316) communicate with each other over WAN facilities 344, utilizing a secure channel, in order to (1) allow the RIDs 328, 328′ to establish and maintain secure connections with their respective remote office communicating computers 340, 340′, 340″, 340′″ on behalf of the data center communicating computers 320, 320′; and (2) to relay and perform beneficial processing on data between the remote office communicating computers 340, 340′, 340″, 340′″ and the data center communicating computers 320, 320′.

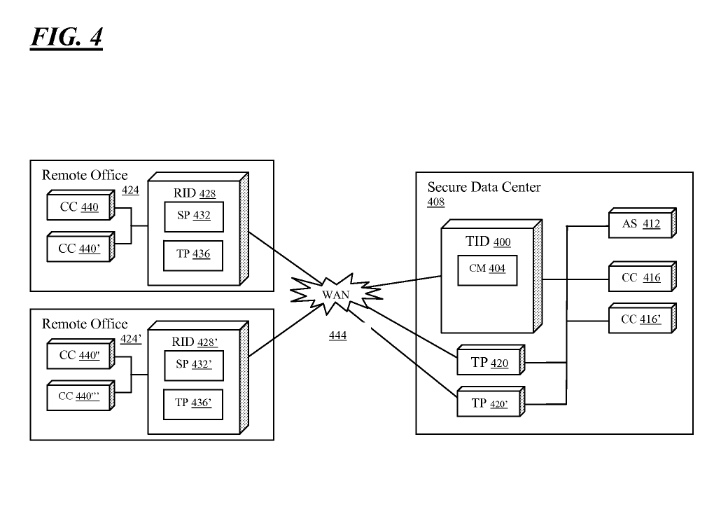

Referring to FIG. 4, in still another configuration a TID 400, containing a credentials manager 404, resides in a secure data center 408, interconnected over LAN facilities to an authentication service 412, one or more communicating computers 416, 416′, and one or more other intermediate devices, each containing a traffic processor 420, 420′, also located in the data center 408. In one or more remote offices 424, 424′, two RIDs 428, 428′, each containing a security proxy 432, 432′ and a traffic processor 436, 436′, are interconnected over LAN facilities to one or more communicating computers located in its remote office 440, 440′, 440″, 440′″. According to the invention, the RIDs 428, 428′ and the TID 400 (possibly involving the authentication service 412) communicate with each other over WAN facilities 444, utilizing a secure channel, in order to allow the RIDs 428, 428′ to establish and maintain secure connections with their respective remote office communicating computers 440, 440′, 440″, 440′″ on behalf of the data center communicating computers 416, 416′. Furthermore, the RIDs 428, 428′ and the intermediate devices in the data center containing the traffic processors 420, 420′ communicate with each other over WAN facilities 444, utilizing a secure channel, in order to relay and perform beneficial processing on data between the remote office communicating computers 440, 440′, 440″, 440′″ and the data center communicating computers 416, 416′.

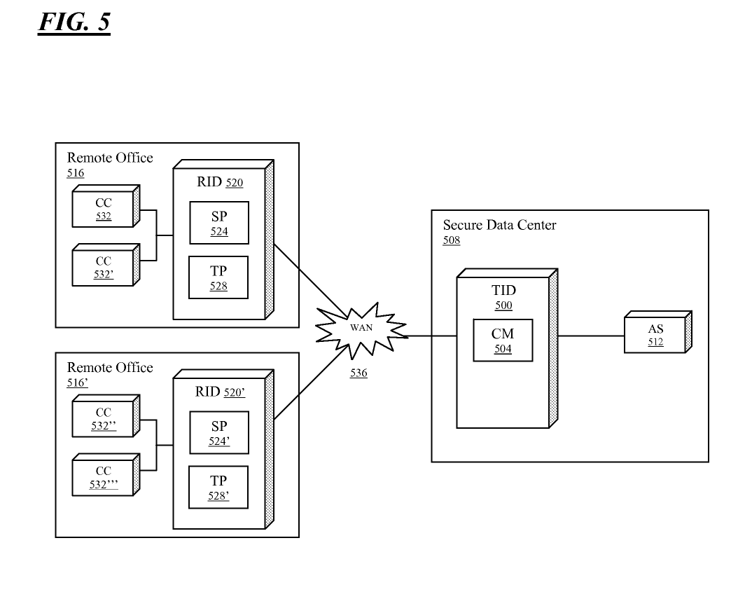

Referring to FIG. 5, in yet another configuration a TID 500, containing a credentials manager 504, resides in a secure data center 508, interconnected over LAN facilities to an authentication service 512, also located in the data center 508. In one or more remote offices 516, 516′, two RIDs 520, 520′, each containing a security proxy 524, 524′ and a traffic processor 528, 528′, are interconnected over LAN facilities to one or more communicating computers located in remote offices 532, 532′, 532″, 532′″. According to the invention, the RIDs 520, 520′ and the TID 500 (possibly involving the authentication service 512) communicate with each other over WAN facilities 536, utilizing a secure channel, in order to allow the RIDs 520, 520′ to establish and maintain secure connections with their respective remote office communicating computers 532, 532′, 532″, 532′″ on behalf of communicating computers located in other remote offices 532, 532′, 532″, 532′″. Furthermore, the RIDs 520, 520′ communicate with each other over WAN facilities 536, utilizing a secure channel, in order to relay and perform beneficial processing on data between their respective remote office communicating computers 532, 532′, 532″, 532′″.

Certain embodiments and configurations of the present invention were described above. It is, however, expressly noted that the present invention is not limited to those embodiments, but rather the intention is that additions and modifications to what was expressly described herein are also included within the scope of the invention. Moreover, it is to be understood that the features of the various embodiments described herein are not mutually exclusive and can exist in various combinations and permutations, even if such combinations or permutations were not made express herein, without departing from the spirit and scope of the invention. In fact, variations, modifications, and other implementations of what was described herein will occur to those of ordinary skill in the art without departing from the spirit and the scope of the invention. As such, the invention is not to be defined only by the preceding illustrative description but instead by the scope of the claims.

What is claimed is:

1. A method of communicating data between first and second computers located remotely from each other, the method comprising:
a. providing a security proxy, and a credentials manager comprising a database and a facility for deriving transitory credentials;
b. establishing a secure communications session between the first computer and the security proxy, utilizing communications between the security proxy and the credentials manager; and
c. conducting a communications session between the first and second computers via the security proxy.

2. The method of claim 1 wherein the security proxy processes secured traffic from the first computer and forwards the traffic to the second computer.

3. The method of claim 2 wherein the security proxy processes secured traffic without further involvement from the credentials manager.

4. The method of claim 2 wherein processing includes at least one of authentication, decryption, and anti-replay.

5. The method of claim 1 wherein the security proxy processes unsecured traffic from the second computer and processes it into secured traffic which is forwarded to the first computer.

6. The method of claim 5 wherein the security proxy processes unsecured traffic into secured traffic without further involvement from the credentials manager.

7. The method of claim 5 wherein processing includes at least one of authentication, encryption, and anti-replay.

8. The method of claim 1 wherein the security proxy is co-located with the first computer.

9. The method of claim 1 wherein the facility for deriving transitory credentials utilizes persistent credentials.

10. The method of claim 9 wherein the persistent credentials are derived via communication with an authentication service.

11. The method of claim 9 wherein the persistent credentials are stored in a database.

12. The method of claim 9 wherein the persistent credentials are at least one of passwords, private keys, and other secret information known by the second computer, and the credentials manager performs all operations using the persistent credentials so as to exclude the first computer and the security proxy from access thereto.

13. The method of claim 1 further comprising causing the security proxy to establish and maintain the secure connection with the first computer, further comprising at least one of authentication, session key derivation, encryption and decryption, and anti-replay with respect to traffic communicated over the secure connection.

14. The method of claim 13 wherein the transmitted traffic undergoes at least one of acceleration, traffic management and monitoring, and content filtering.

15. The method of claim 14 wherein facilities performing acceleration, traffic management and monitoring, and content filtering are co-located with both the first and second computer.

16. A method of communicating data between first and second computers located remotely from each other, the method comprising:
a. providing first and second security proxies, and a credentials manager comprising a database and a facility for deriving transitory credentials;
b. establishing a secure communications session between the first computer and the first security proxy, utilizing communications between the first security proxy and the credentials manager;
c. establishing a secure communications session between the second computer and the second security proxy, utilizing communications between the second security proxy and the credentials manager; and
d. conducting a communications session between the first and second computers via the first and second security proxies.

17. The method of claim 16 wherein the first security proxy processes secured traffic from the first computer and forwards the traffic to the second computer via the second security proxy.

18. The method of claim 17 wherein the first security proxy processes secured traffic without further involvement from the credentials manager.

19. The method of claim 17 wherein processing includes at least one of authentication, decryption, and anti-replay.

20. The method of claim 16 wherein the first security proxy processes unsecured traffic from the second security proxy, such traffic originating from the second computer, and processes it into secured traffic which is forwarded to the first computer.

21. The method of claim 20 wherein the first security proxy processes unsecured traffic into secured traffic without further involvement from the credentials manager.

22. The method of claim 20 wherein processing includes at least one of authentication, encryption, and anti-replay.

23. The method of claim 16 wherein the second security proxy processes secured traffic from the second computer and forwards the traffic to the first computer via the first security proxy.

24. The method of claim 23 wherein the second security proxy processes secured traffic without further involvement from the credentials manager.

25. The method of claim 23 wherein processing includes at least one of authentication, decryption, and anti-replay.

26. The method of claim 16 wherein the second security proxy processes unsecured traffic from the first security proxy, such traffic originating from the first computer, and processes it into secured traffic which is forwarded to the second computer.

27. The method of claim 26 wherein the second security proxy processes unsecured traffic into secured traffic without further involvement from the credentials manager.

28. The method of claim 26 wherein processing includes at least one of authentication, encryption, and anti-replay.

29. The method of claim 16 wherein the first security proxy is co-located with the first computer and the second security proxy is co-located with the second computer.

30. The method of claim 16 wherein the facility for deriving transitory credentials utilizes persistent credentials.

31. The method of claim 30 wherein the persistent credentials are derived via communication with an authentication service.

32. The method of claim 30 wherein the persistent credential are stored in a database.

33. The method of claim 30 wherein the persistent credentials are at least one of passwords, private keys, and other secret information known by the second computer, and the credentials manager performs all operations using the persistent credentials so as to exclude the first computer and the first security proxy from access thereto.

34. The method of claim 30 wherein the persistent credentials are at least one of passwords, private keys, and other secret information known by the first computer, and the credentials manager performs all operations using the persistent credentials so as to exclude the second computer and the second security proxy from access thereto.

35. The method of claim 16 further comprising causing the first security proxy to establish and maintain the secure connection with the first computer, further comprising at least one of authentication, session key derivation, encryption and decryption, and anti-replay with respect to traffic communicated over the secure connection.

36. The method of claim 35 wherein the transmitted traffic undergoes at least one of acceleration, traffic management and monitoring, and content filtering.

37. The method of claim 16 further comprising causing the second security proxy to establish and maintain the secure connection with the second computer, further comprising at least one of authentication, session key derivation, encryption and decryption, and anti-replay with respect to traffic communicated over the secure connection.

38. The method of claim 37 wherein the transmitted traffic undergoes at least one of acceleration, traffic management and monitoring, and content filtering.

39. A system for the processing of data communicated between first and second computers located remotely from each other, the system comprising:
a. a security proxy and a credentials manager comprising a database and a facility for deriving transitory credentials;
b. a secure communications session established between the first computer and the security proxy, which utilizes communications between the security proxy and the credentials manager; and
c. a communications session conducted between the first and second computers via the security proxy.

40. The system of claim 39 wherein the communications between the security proxy and the credentials manager is via a secure channel between the two.

41. The system of claim 39 wherein the secure communications session between the first computer and the security proxy is performed using at least one of IPsec, SSL, TLS, SMB signing, and WSS.

42. The system of claim 41 wherein authentication steps performed between the first computer and the security proxy use at least one of PKI certificates, NTLM challenge/responses, Kerberos tickets, and shared secrets.

43. A system for the processing of data communicated between first and second computers located remotely from each other, the system comprising:
a. first and second security proxies and a credentials manager comprising a database and a facility for deriving transitory credentials;
b. a secure communications session established between the first computer and the first security proxy which utilizes communications between the first security proxy and the credentials manager;
c. a secure communications session established between the second computer and the second security proxy which utilizes communications between the second security proxy and the credentials manager; and
d. a communications session conducted between the first and second computers via the first and second security proxies.

44. The system of claim 43 wherein the communications between the first security proxy and the credentials manager is via a secure channel between the two.

45. The system of claim 43 wherein the secure communications session between the first computer and the first security proxy is performed using at least one of IPsec, SSL, TLS, SMB signing, and WSS.

46. The system of claim 45 wherein authentication steps performed between the first computer and the first security proxy use at least one of PKI certificates, NTLM challenge/responses, Kerberos tickets, and shared secrets.

47. The system of claim 43 wherein the communications between the second security proxy and the credentials manager is via a secure channel between the two.

48. The system of claim 43 wherein the secure communications session between the second computer and the second security proxy is performed using at least one of IPsec, SSL, TLS, SMB signing, and WSS.

49. The system of claim 48 wherein authentication steps performed between the second computer and the second security proxy use at least one of PKI certificates, NTLM challenge/responses, Kerberos tickets, and shared secrets.

50. The system of claim 43 wherein traffic is exchanged between the first and second security proxies via a secure channel between the two.
